(19) United States
(12) Patent Application Publication
(10) Pub. No.: US 2017/0061077 A1
(43) Pub. Date: Mar. 2, 2017

(54) MEDICAL VISUAL REFERRAL TOOL AND REMOTE PORTAL

(71) Applicant: LIGHTBEAM HEALTH SOLUTIONS, LLC, IRVING, TX (US)

(72) Inventors: Patrick CLINE, Irving, TX (US); Robert NARY, Irving, TX (US); Michael HOXTER, Irving, TX (US); Jerry SHULTZ, Irving, TX (US)

(21) Appl. No.: 15/248,709

(22) Filed: Aug. 26, 2016

Related U.S. Application Data
(60) Provisional application No. 62/210,162, filed on Aug. 26, 2015.

(51) Int. Cl. G06F 19/00; G06F 17/30

(52) U.S. Cl. CPC G06F 19/322; G06F 17/30061

(57) ABSTRACT

A method and system being used to provide patient/provider information for use by a medical visual referral tool, the method being carried out by one or more servers, wherein the one or more servers comprises at least one database stored on a computer-readable memory, wherein each of the servers comprises a plurality of electronic computing machines, wherein the electronic computing machines each comprise a processor and a computer-readable memory, and wherein the method comprises: obtaining data from data sources, standardizing the data, storing the data in one or more of the databases, receiving a client request from a client computing machine, processing the client request, and sending a response to the client computing machine, wherein the response provides the patient/provider information usable for the medical visual referral tool, and wherein at least some of the patient/provider information is to be displayed on an electronic geographical map at the client machine.

### BACKGROUND OF THE INVENTION

1. Field of the Invention

The invention relates to the field of coordinating patient healthcare and, more particularly, to a method of providing patient/provider information to be used for a medical visual referral tool.

2. Description of the Related Art

Today, health systems, healthcare providers, healthcare professionals, payers and risk bearing entities do not have a solution that allows them to efficiently generate patient referrals and coordinate patient care in a graphical manner combining applications and other visual cues with pertinent data. They cannot efficiently view providers and provider information on a map and filter their selection by visual cues representing patient preferences, cost, quality, patient satisfaction, outcomes, plan/network affiliation, availability, and/or distance from a patient's home or access to public transportation.

### SUMMARY OF THE INVENTION

According to an embodiment of the invention, there is provided a method of providing patient/provider information to be used for a medical visual referral tool. The method is carried out by one or more servers, wherein the one or more servers comprises at least one database stored on a computer-readable memory. Each of the servers comprises a plurality of electronic computing machines, wherein the electronic computing machines each comprise a processor and a computer-readable memory. The method comprises: obtaining electronically encoded data from one or more data sources, wherein the electronically encoded data comprises information pertaining to a patient and/or a medical provider; preparing the data for standardized entry into one or more of the databases using the processor of at least one of the electronic computing machines; storing the standardized data into the one or more databases; receiving a client request for access to the medical visual referral tool from an electronic client computing machine via an inter-connected electronic data network; resolving the client request to a user; processing the client request by querying the at least one database for patient/provider information pertaining to the user, to a patient of the user, to a provider of the user, or to a potential provider of the user, using a visual selection referral application installed on one or more of the electronic computing machines; and sending a response to the electronic client computing machine over the inter-connected electronic data network, wherein the response provides the patient/provider information usable for the medical visual referral tool, and wherein at least some of the patient/provider information is to be visually represented at the client machine and displayed on an electronic geographical map.

According to another embodiment of the invention, there is provided a medical visual referral system, comprising: at least one database stored on a computer-readable memory; and one or more servers. The one or more servers each comprise: a plurality of electronic computing machines, wherein the electronic computing machines each comprise: a processor; and a computer-readable memory accessible by the processor. The electronic computing machines are configured to: obtain electronically encoded data from one or more data sources, wherein the electronically encoded data comprises information pertaining to a patient and/or a medical provider; prepare the data for standardized entry into one or more of the databases using the processor of at least one of the electronic computing machines; store the standardized data into the one or more databases; receive a client request for access to the medical visual referral tool from an electronic client computing machine via an inter-connected electronic data network; resolve the client request to a user; process the client request by querying the at least one database for patient/provider information pertaining to the user, to a patient of the user, to a provider of the user, or to a potential provider of the user, using a visual selection referral application installed on one or more of the electronic computing machines; and send a response to the electronic client computing machine over the inter-connected electronic data network, wherein the response provides the patient/provider information usable for the medical visual referral tool, and wherein at least some of the patient/provider information is to be visually represented at the client machine and displayed on an electronic geographical map.

According to yet another embodiment of the invention, there is provided a method of providing patient/provider information to be used for a medical visual referral tool, the method being carried out by a medical visual referral system. The medical visual referral system comprises: at least one database stored on a computer-readable memory; and one or more servers. Each of the servers comprises a plurality of electronic computing machines, wherein the electronic computing machines each comprise a processor and a computer-readable memory that is accessible by the processor. The method comprises: obtaining electronically encoded data from one or more data sources via an inter-connected data network, wherein the electronically encoded data comprises information pertaining to a patient and/or a medical provider; standardizing the obtained electronically encoded data using the processor of at least one of the electronic computing machines; storing the standardized data into one or more of the databases; receiving a client request from the medical visual referral tool via an inter-connected electronic data network, wherein the medical visual referral tool is being carried out on an electronic client computing machine; resolving the client request to a user of the medical visual referral tool; retrieving patient/provider information pertaining to the user, to a patient of the user, to a provider of the user, or to a potential provider of the user, from any one or more of the databases using a visual selection referral application installed on one or more of the electronic computing machines; and sending a response to the electronic client computing machine over the inter-connected electronic data network, wherein the response provides the patient/provider information usable for the medical visual referral tool, and wherein at least some of the patient/provider information is displayed on an electronic geographical map at the electronic client computing machine.

### BRIEF DESCRIPTION OF THE DRAWINGS

Preferred exemplary embodiments will hereinafter be described in conjunction with the appended drawings, wherein like designations denote like elements, and wherein:

FIG. 1 is a schematic drawing of an embodiment of a medical visual referral system that is capable of carrying out the methods disclosed herein;

FIG. 2 illustrates an example of a user interface of a medical visual referral tool at a client machine that is usable with a remote visual selection referral portal; and

FIG. 3 is a flowchart depicting an embodiment of a method of providing patient/provider information to be used for a medical visual referral tool.

### DETAILED DESCRIPTION OF THE INVENTION

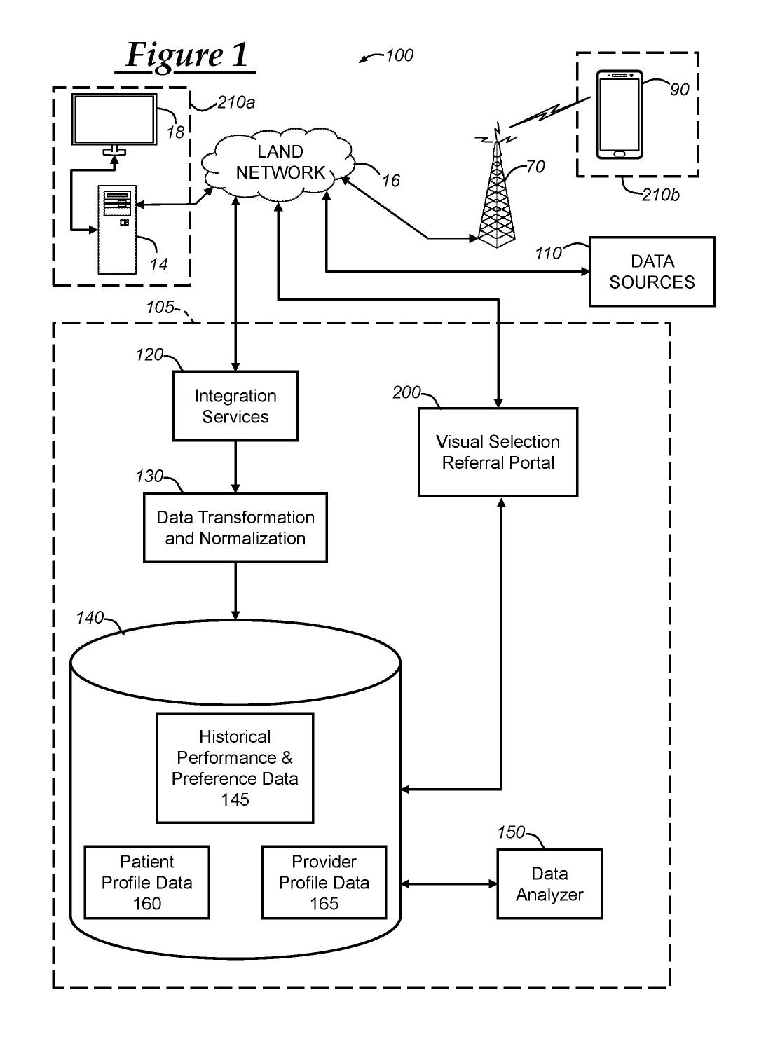

FIG. 1 represents one embodiment of a medical visual referral system 100 that is capable of carrying out the method disclosed herein. The system 100 can work completely on a stand-alone basis or with aggregated data from third party data sources 110 (only one shown). The system 100 may include one or more servers, such as server 105 (only one shown). The server(s) may carry out the method provided herein and each server may, in some embodiments, include a plurality of electronic computing machines and at least one database stored on a computer-readable memory. As used herein, an electronic computing machine may be a computer, processing system, or other computing device capable of carrying out computer instructions.

FIG. 1 represents a medical visual referral system 100 configured to gather broad and discrete data on a real time basis or in batch from multiple data sources 110. The data sources may be located at a location remote from the location of the one or more servers. In such an embodiment, the data sources may be accessible by the integration services 120 (or other component of the servers) via an inter-connected data network, such as the Internet. Alternatively, the data sources may be stored on a non-volatile computer-readable medium, such as ROM, a compact disc (CD), or a flash drive. The data sources may then be locally connected to the one or more servers or database. Any data that upon observation could be related to determining provider performance and/or patient default preferences may be assembled into a consumable format by the system 100. The integration services 120 and data transformation and normalization 130 gather and prepare any data that upon observation could be used in a referral process. Data is then stored in one or more databases 140 (only one shown) at one or more servers 105 (only one shown). The data may be stored in one or more tables, partitions, or databases based on the type of data or the source of the data. For example, data relating to past provider performance and outcomes may be stored in a table corresponding to the historical performance and outcomes data 145 and analyzed by data analyzer 150. Visual referral portal 200 may provide information from database 140 to users 210a,b that are operating an electronic client computing machine via an inter-connected electronic data network, which may include the cloud, Internet, TCP/IP connections, VPN, and other types of connections including mobile devices using Android, iOS, Windows Mobile and Blackberry.

The system 100 is capable of operating on a “standalone basis” and without data gathered from data sources 110, integrated by integration services 120 and transformed by data manipulator 130. Users 210a,b can create and maintain patient 160 and provider 165 profiles using the visual selection referral portal 200. Patient 160 and provider 165 profile data can also be assembled from data gathered from multiple sources 110 including but not limited to claims, ambulatory systems, EHRs, inpatient systems, electronic medical records, HIE's, payers, care management systems, Lightbeam's Analytics Platform, third party analytics systems, prescription data from pharmacies, Rx aggregators and PBMs, labs, patient biometric monitoring devices, genomic databases, search engines, provider rating services, patient satisfaction and survey data.

In some embodiments, integration services layer 120 provides the transport infrastructure and supports current and future standards based interfaces such as HL7, CCD, CCR, XML, SOA, custom APIs, claims, and where applicable the IHE profiles used to integrate such as xdr, xds.b, etc. Integration services 120 may also support custom interfaces, capable of reaching directly into source systems to extract data. In one embodiment, integration servers 120 may comprise a computer application running on an electronic computing machine which is configured to download data from one or more data sources 110 using land network 16. In such an embodiment, the servers 105 may receive electronically encoded data from one or more data sources. The data may comprise information pertaining to a patient and/or a medical provider. Then, upon download of the data, integration services 120 may use an application to process the data and then pass the data to data transformation and normalization 130.

In some embodiments, the medical visual referral system uses data transformation and normalization 130 to map, transform and normalize data from data sources 110 and store the mapped, transformed, and normalized data in database 140. Therefore, in such an embodiment, users of the medical visual referral tool are able to compare performance, outcomes, quality, utilization, cost and satisfaction data from third party sources and quality measures. The data transformation and normalization may be carried out by one or more electronic computing machines. In such an embodiment, the data transformation and normalization 130 may be a set of computer instructions that are carried out on the electronic computing machine(s) as part of an application. In one embodiment, the integration services 120 and data transformation and normalization are separate applications carried out on the same computing machine; however, one skilled in the art will appreciate that there are many different software and hardware configurations enabling such processes to be carried out.

Data transformation and normalization 130 may be used to facilitate the mapping of data from data sources using various terminology, codes, and abbreviations into a normalized data set within the database 140. The normalization will facilitate the execution of filtering on the provider dataset and provides a more complete and comprehensive view of providers when generating a referral. In one embodiment, data transformation and normalization 130 prepares the received data for standardized entry into one or more of the databases using the processor of at least one of the electronic computing machines located at server(s) 105. As used herein, “standardize” includes mapping, transforming, and/or normalizing. The database 140 stores historical cost data gathered from sources 110 such as payer claims and other cost related data. By statistically referencing, cross referencing, and analyzing the historical cost information for patients and populations against combinations of the discrete information gathered and organized in the database 140, the system may be able to identify the specific costs for each data element, or factor, and each data element combination. Based on this information the data analyzer 150 is able to create normalized numerical or statistical factor(s), for each element. By way of example, a data element would be representative of a condition, such as COPD, and cross-referenced to providers associated with each factor. Tables in database 140 may store factors such as but not limited to the actual dollar amounts as well those used to determine quality for the patients and populations with the same combinations.

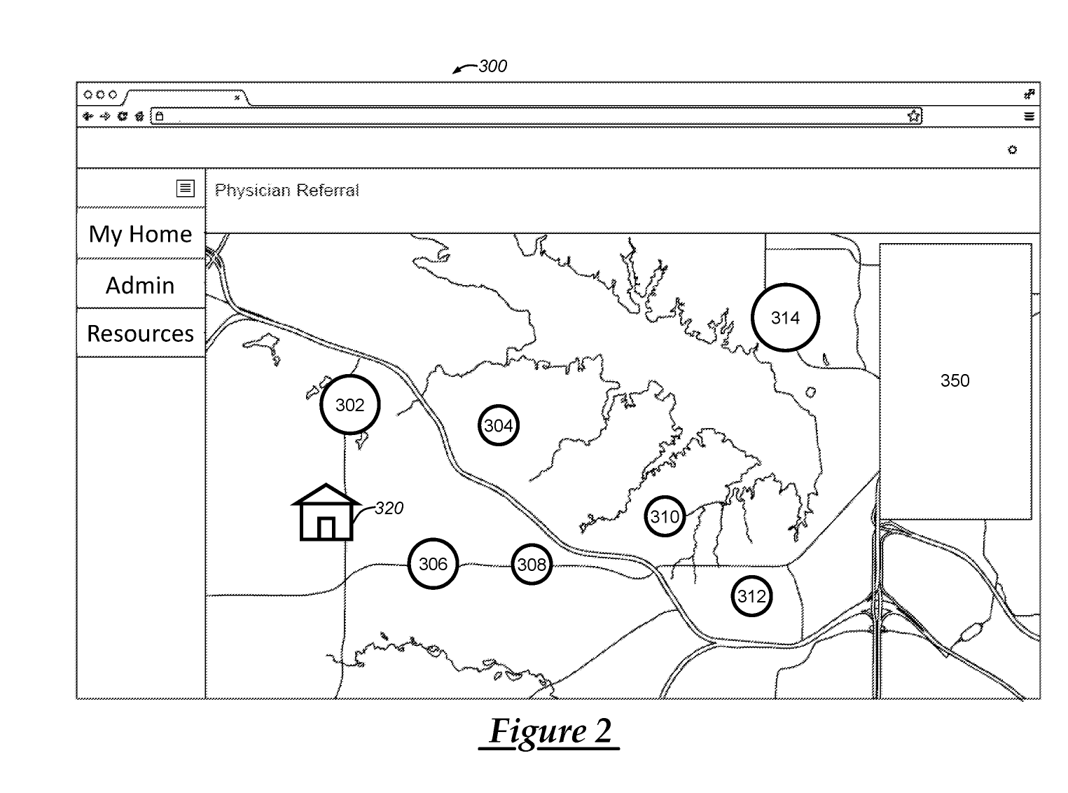

The data is linked to a provider by the data transformation and normalization 130, and stored in database 140. In some embodiments, data analyzer 150 is used to calculate performance metrics, including scores or grades, that will be stored in provider profile 165 and displayed by the medical visual referral tool 300 (FIG. 2) through operation of visual selection referral portal 200. A performance metric of a provider may include any data concerning past performance by the provider, including any provider reviews, patient satisfaction ratings, costs, provider quality scores, and quality of services or goods. Data analyzer 150 evaluates data stored in the historical performance and preference data 145. In one embodiment, data analyzer 150 is carried out at server(s) 105 and comprises a set of computer instructions carried out on one or more processors of one or more electronic computing machines. Additionally, data analyzer is electronically coupled to database 140 such that it may query database 140 and/or perform other database operations thereon, such as performing insertion, modification, and/or deletion operations on data tuples, tables, or other data structures. Data analyzer 150 may use computerized database interfacing software, such as SQL, MySQL, Microsoft SQL Server, and/or other suitable database management systems (DBMS).

In some embodiments, criteria used to select the provider that a patient will be referred to may include cost, quality and patient satisfaction ratings. The data analyzer 150 may determine the cost rating by calculating the average from claims and cost data (140) of all services, or factors, related to a provider and/or to specific procedure(s) and providers. Additionally, or alternatively, the data analyzer 150 may determine an average cost/provider and an average provider/procedure by dividing the total costs associated with each provider in total, for procedures they perform and for the diagnosis codes for the patients they treat. Subsequently, the data analyzer 150 may group all related costs associated with past episodes including but not limited to surgery costs, facility fees, medication costs, skilled nursing facilities, physical therapy, DME, other provider costs, and then determines a median average cost for all providers and/or that service. After determining the median average cost, data analyzer 150 may look back at and records each provider and/or procedure combination and determines where he or she falls on that scale.

Visual selection referral portal 200 then may be used to visually represent this information graphically based on a provider falling in the lower or higher range of the cost scale. Indicators 302-314 may be used to graphically represent such information. A lower cost provider could be set to appear on the map with a green icon, a provider falling in the moderate price range might be set to appear in yellow while high cost providers are shown in red. A user can also set preferences to display this information with icons like a $ ranging from $ to $$$$ from low to high. It is important to note that the term provider, or providers of service applies to a broad category of service providers including but not limited to facilities, DME providers, hospitals, surgical centers, rehab facilities, diagnostic/lab related costs, and medication costs. To further illustrate this capability by way of example, suppose a patient needs a referral to an orthopedic surgeon for a knee joint replacement and that there are 5 orthopedic surgeons (Providers A, B, C, D, E) that have performed the procedure. The Data Analyzer 150 may determine that the average of the total cost of the joint replacement including the joint, provider fees, facility fees, medications, physical therapy and rehab is $80,000 and range is from $60,000 to $100,000. Providers A and B, with average costs in the lowest tier will be given a high cost rating and displayed accordingly on the map using, for example, indicators 302-314—perhaps the user will use green to display providers with the best cost rankings or with 1 $. Providers C, near the middle will be rated as such and color coded accordingly (yellow or with (2) $$), and providers D and E whose average cost to perform the joint replacement are near $100,000 will appear in red or with (3) $$$ depending on user preference settings in 200. The visual selection referral portal 200 can also be set to shows exactly where each provider (A-E) falls on the scale as to delineate between multiple low cost choices with a “best price” indicator or numerical ranking.

A provider quality rating or provider quality index can be determined by evaluating factors that upon observation by data analyzer 150 are determined to be related to and connected with a provider or a service for which the referral will be generated. These factors may include but are not limited to health quality measures as well as infection rates, hospital admissions, hospital re-admission rates, ER Visits, complication rates, the need for unplanned or excess follow-up services like physical therapy, the volume of procedures performed by the provider, and third party quality rating systems. The integrations services 120 and data transformation and normalization 130 may prepare data from data sources 110 for reference and storage by historical data 145 that can be used by data analyzer 150 to create a provider quality rating. Quality scores can also be adjusted or weighted by factors such patient risk scores stored in patient profile 160. Patient risk scores may be supplied by third party sources 110 and typically can be calculated by evaluating factors including but not limited to total previous spent, number of chronic conditions, age, weight/BMI, blood pressure, depression scores, ability to drive, marital status, patients support network, and likelihood of future spend. The data analyzer 150 determines an average quality rating/provider and an average provider/procedure by performing a factorial analysis on the total number of quality factors associated with each provider in total, and for procedures they perform or for the diagnosis codes for the patients they treat. The data analyzer 150 indexes and groups all related quality factors associated with past episodes by provider including but not limited to surgery costs, facility fees, medication costs, skilled nursing facilities, physical therapy, DME, and/or other providers.

Data analyzer 150 can, in some embodiments, perform a factorial analysis on quality factors related to a provider and provider/procedure and determines an average score for the factors associated with each provider. After determining the median average, the data analyzer 150 then may look back at and record each provider and/or procedure combination and determines where he or she falls on the quality index. To illustrate this capability by way of example let us refer back to the need to generate a referral to an orthopedic surgeon to perform a knee replacement. Factors determined by the data transformation and normalization 130 to be related to an episode of care and cross-referenced to “knee replacement,” providers performing that service as well as their quality score from the provider quality index are evaluated by data analyzer 150. When evaluating the available choices to perform this procedure the user will be able to visually review the quality score for each provider for that service from the quality index. The visual selection referral portal 200 may then display quality scores on the map for each provider using icons 302-314, which can be different colors or sizes, to reference where each provider falls on the quality index. Perhaps that we see there are 2 choices with relatively equal costs but that Provider A has a quality score of 8.7 while Provider B has a quality score of 7.5, with 10 being the highest possible rating from the index. The user generating the referral can use both cost and quality to determine who to refer the patient to. Factors used to determine the quality score for procedures like “knee replacement” might include joint failure/replacement rates, hospital re-admission rates, infection rates, ER Visits within 30 days post-op, the amount of physical therapy that the patient incurred postop, amount of work missed, ability to return to normal work schedule, and pain medications used post op.

Additionally, the system and/or method herein may be used to present quality scores from third party sources including but not limited to services like Healthgrades on the visual referral tool's map as described above.

Patient satisfaction rating can be calculated by compiling and normalizing patient survey responses collected by integration services 120 and transformed by the data transformation and normalization 130. The data analyzer 150 can determine an average patient satisfaction rating/provider and an average provider/procedure by averaging the satisfaction scores associated with each provider, and for procedures they perform. After determining the median average, the data analyzer then looks back at and records each provider and/or procedure combination and determines where he or she falls on that scale or index. Visual selection referral portal 200 then may visually represent patient satisfaction information graphically based on a provider falling in the lower or higher range of the satisfaction index. A provider with a lower satisfaction rating could be set to appear on the map with a “sad face” within the icon, a provider falling in the moderate patient satisfaction range might be set to appear with a “frown” while those with a high patient satisfaction rating are shown with a “smiley face.” The visual selection referral portal 200 also can be used to send a survey to the patient for completion via email, secure email, texting, or IVR. A link to a web form that can be sent includes an attachment that the patient 210 clicks on via use of the tool at an Internet browser. Patient responses are brought back by integration services 120, transformed by the data transformation and normalization 130 and stored in database 140 for future reference by data analyzer 150. Patient satisfaction scores from third party consumer rating services including but limited to WebMD and Health Grades can also be used to determine and display provider satisfaction scores when generating a referral.

In some embodiments, a user 210 may use the visual selection referral portal 200 to select a physician to receive a referral. This selection can be based upon but not limited to criteria such as:

whether the physician in-network;

the quality rating of the physician;

the specialty of the physician;

the proximity of the physician to the patient;

the availability of the physician;

the provider's historical cost of services or cost rating;

what is the provider's patient satisfaction rating; and

patient preferences.

When the user 210 wants to make a referral, they would invoke the software functions available in the visual selection referral portal 200. In one embodiment, the user would operate computer 14 or mobile device 90 such that a client request for access to the medical visual referral tool is generated and sent to server(s) 105. One or more electronic computing machines at server 105 may then receive the client request via an inter-connected electronic data network, such as land network 16 and/or cellular network 70. The user may invoke generation and sending of the client request via navigation to a specified website or IP address, which resolves to one or more devices located at server 105. The navigation may be carried out via an Internet or network browser on computer 14 or mobile device 90; alternatively, a computer application or mobile application may be operated by the user wherein the application generates and sends such a client request.

After the server 105 receives the client request, the client request may be resolved to a user. For example, the client request may contain a user identifier, username, or other identifying information that associates a user with the medical visual referral tool. After the client request is resolved to a user, the client request may be processed by querying at least one database for patient/provider information pertaining to the user, to a patient of the user, to a provider of the user, or to a potential provider of the user, using a visual selection referral application installed on one or more of the electronic computing machines. In one embodiment where the user is a medical provider, the database 140 may be queried to retrieve data from historical performance and preference data 145 and/or provider profile data 165. Additionally, patient profile data 160 may be queried for information pertaining to one or more patients or potential patients of the user. In another embodiment where the user is a patient, the database 140 may be queried for information pertaining to the user or to information useful to the user, such as for information regarding certain providers nearby the user's home location. The foregoing processing of the client request may be carried out by a visual selection referral portal 200 located at server 105. Visual selection referral portal 200 may be a computer application installed on one or more electronic computing machines each comprising a processor and a computer-readable memory.

After the client request is processed, a response is generated and sent to the electronic client computing machine over the inter-connected electronic data network. The response may be generated and sent by visual selection referral portal 200 and may include patient/provider information that is usable for the medical visual referral tool at the client computing machine. The response may include data that was retrieved from database 140 or may include data or information that was generated based on data retrieved from the database 140. In one embodiment, the response includes patient/provider information corresponding to one or more geographic locations that is usable by the medical referral tool such that the patient/provider information may be displayed on an electronic geographical map at the electronic client computing machine.

In one embodiment, the application or webpage may bring up a map, as is shown in FIG. 2, showing the patient's address and all physicians that match any default criteria as shown in indicators 302-314. Default search criteria can be stored in patient profile 160. FIG. 2 depicts the patient address by placing a graphical house icon 320 directly on the map. The tool allow may allow users to configure and personalize icons that are presented on the map.

Any default or preference criteria such as “patient only wants in-network providers displayed” are stored in 160 and 165 can be applied. Patient and practice default search criteria are described throughout this disclosure and include things like “in-network,” “minimum quality score ratings,” “cost,” “proximity,” etc.

The user 210 can also alter the default or preferred search criteria on the fly, which will automatically change the display (removing or adding providers/physicians as criteria changes). The default search preference can be changed from “Display All” in FIG. 2 to “In Network” through configuring certain options using panel 350. Users can quickly alter search criteria for any number of factors including but not limited to plan affiliations, distance from patients home, minimum quality rating, minimum patient satisfaction score, language preference, access to public transportation, cost, outcomes, re-admission rates, etc.

Size of the indicator (icon) showing the physician's address can signify quality rating. FIG. 2 illustrates one way of depicting quality in the provider indicator. The higher the rating, the larger the indicator. The lower the rating the smaller the provider indicator.

Cost of services or cost rating can be signified with colors and shading of indicators 302-314. For example, Red may be high cost and green may be low cost. Yellow is mid-range. Color shades, such as green, can be used to draw a user's attention to the providers with the lowest cost. The darker the shade of a color indicates performance that is higher above the target value.

Within the indicator, an icon can will indicate in-network or out of network. The use of icons can be used to visually illustrate if a provider is an “in-network provider” or “out-of-network provider” through using certain icons placed in each indicator 302-314. Again, the tool allows users to configure and personalize icons that are presented on the map.

The provider indicator icon can also be configured to indicate patient satisfaction ratings. This feature can be illustrated by using smiley faces and frowning faces at indicators 302-314. The larger the smile the higher the patient satisfaction rating. Inversely the frown (or sad face) increases as patient satisfaction drops. In another embodiment, patient satisfaction is depicted by “thumbs up” and “thumbs down”.

When clicking on or selecting a provider indicator, a box, such as panel 350 or another panel located displayed over the map, will pop up showing the provider name, address, quality rating, cost rating, availability, etc. A link will be displayed called “refer” which will be used to trigger a referral program or function which will generate an electronic referral or referral message to the selected provider complete with appropriate data and attachments.

During such a referral process, the system may retain the patient's preferences such that they may later be recalled and applied during future searches.

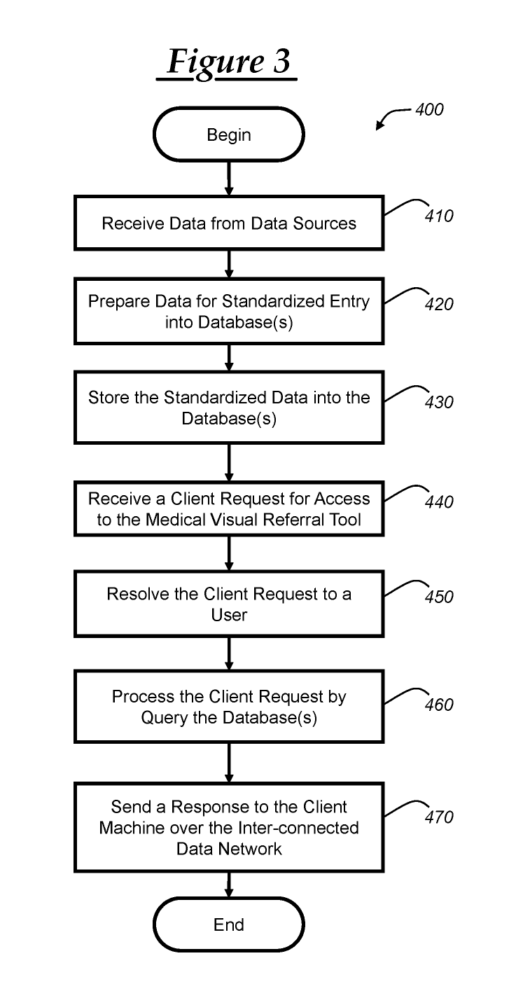

FIG. 3 depicts an embodiment of a method 400 of providing patient/provider information to be used for a medical visual referral tool. The method 400 comprises a data fetching and standardization process (steps 410 to 430) and a client request processing and response generation process (steps 440 to 470). In many embodiments, the method 400 may be carried out by one or more servers, wherein the one or more servers comprises at least one database stored on a computer-readable memory. Additionally, at least in some embodiments, each of the servers comprises a plurality of electronic computing machines, wherein the electronic computing machines each comprise a processor and a computer-readable memory.

The method 400 begins with step 410 wherein one or more servers receive electronically encoded data from one or more data sources. In some embodiments, the electronically encoded data comprises information pertaining to a patient and/or a medical provider. In one embodiment, the data is gathered by integration services 120. In such an embodiment, integration services 120 may be a computer application running on one or more servers and configured to download data from one or more data sources 110 using an inter-connected data network, such as land network 16 and/or cellular network 70. In another embodiment, data may be located and/or retrieved from the data sources in response to the server receiving a client request. Furthermore, the data located and/or retrieved may be based on information contained in the client request. After the data is downloaded, the method proceeds to step 420.

In step 420, the data is prepared for standardized entry into one or more of the databases using the processor of at least one of the electronic computing machines. As described above, data transformation and normalization 130 may be a process or application carried out one an electronic computing machine. In some embodiments, the data transformation and normalization 130 is carried out on the same processor and/or as part of the same process or application as integration services 120. As is also described above, data transformation and normalization may map, transform, normalize, standardize, and/or process the data received at step 410 such that it is in a proper format usable by the medical visual referral tool. In addition, the data may be formatted such that it will be suitable for insertion into one or more databases 140. In an alternative embodiment, the database may comprise one or more data files, such as XML, files, JSON files, and/or comma-separated value files, that are stored on a computer-readable medium.

In step 430, the standardized data is stored in at least one database. In one embodiment, a database management application may carry out one or more insertion operations on database 140. Thereafter, the database management application may carry out a commit operation, such that the insertion is committed to the database(s) 140. After the data is committed to the database, the visual selection referral portal is may be used to query the database, which now includes the newly committed data, for use in hosting the medical visual referral tool.

In step 440, a client request from an electronic client computing machine is received via an inter-connected electronic data network. For example, a user 210a may use a computer 14 to navigate to a certain domain name, URL, or IP address, through use of an Internet browser. The Internet browser may return a login page or other initial user page whereat the user 210a may enter login and/or other authentication information, such as a username and/or password. In other embodiments, the Internet browser may have the login and/or authentication information already stored therein and, thus, the Internet browser may automatically generate a client request with such information. In another embodiment, a user 210b may operate a mobile device 90 in a similar way using an Internet browser or other mobile application. In some embodiments, the client request may be a string of data or bits, including a header and a payload, such as an HTTP request.

In step 450, after the client request is received, the client request may be resolved to a user. For example, using a computer application or other set of computing instructions or operations, an electronic computing device at server 105 may process the client request to obtain a specific user, as indicated, for example, by a username included in the request. Alternatively, or additionally, the computing device may query a database, such as database 140, for information pertaining to the client request such that a user may be resolved. The user may be a patient, a provider, a health system, a healthcare professional, a payer, a risk bearing entity, or a group of any one or more of the preceding.

In step 460, the client request is processed by querying the at least one database for patient/provider information pertaining to information contained or derived from the request. In one embodiment, database 140 may be queried through use of visual selection referral portal 200 for patient/provider information pertaining to the user, to a patient of the user, to a provider of the user, or to a potential provider of the user. The visual selection referral portal 200 may use a database management software or interface to query database 140 and, subsequently, may process the message such that it may be formatted or used to generate a response message.

In step 470, a response is sent to the electronic client computing machine over the inter-connected electronic data network. In some embodiments, the response may comprise metadata information, such as addressing information. Additionally, the response may provide patient/provider information usable for the medical visual referral tool, wherein at least some of the patient/provider information is to be visually represented at the client machine and displayed on an electronic geographical map. For example, the response may comprise geographical locations (e.g., indicated by geographic coordinates, an address) and associated information, such as whether the geographic location corresponds to a user's home (see indicator 320), a provider's primary place of care (see indicators 302-314), or any other useful information, as detailed above. Additionally, the associated information may be performance metrics, such as provider quality scores or costs. In one embodiment, the electronic geographic map may be provided as part of a third part API and/or may be provided as part of the response that is sent.

The medical visual referral tool 300 may be a web application carried out on an Internet browser or may be a separate computer application or mobile application. The medical visual referral tool 300 may be displayed on a computer monitor or other display 18 connected to a computer 14 that carries out the tool 300. Alternatively, the tool 300 may be run on a mobile device 90, which may be a smartphone, and displayed on a screen of the device 90. The method 400 then ends.

It should be appreciated that further correspondence between the medical visual referral tool 300 and the visual selection referral portal 200 may be carried out. For example, the above description discusses the ability of a user to filter and configure certain aspects of the map and indicators displayed thereon. Such filtering may be carried out based on a second client request sent to the one or more servers 105 and subsequent response sent to the client machine in response thereto.

The system and method have been described in an illustrative manner. It is to be understood that the terminology, which has been used, is intended to be in the nature of words of description rather than of limitation.

Many modifications and variations of the system and method are possible in light of the above teachings. Therefore, within the scope of the appended claims, the system and method may be practiced other than as specifically described.

We claim:

1. A method of providing patient/provider information to be used for a medical visual referral tool, the method being carried out by one or more servers, wherein the one or more servers comprises at least one database stored on a computer-readable memory, wherein each of the servers comprises a plurality of electronic computing machines, wherein the electronic computing machines each comprise a processor and a computer-readable memory, and wherein the method comprises:
(a) obtaining electronically encoded data from one or more data sources, wherein the electronically encoded data comprises information pertaining to a patient and/or a medical provider;
(b) preparing the data for standardized entry into one or more of the databases using the processor of at least one of the electronic computing machines;
(c) storing the standardized data into the one or more databases;
(d) receiving a client request for access to the medical visual referral tool from an electronic client computing machine via an inter-connected electronic data network;
(e) resolving the client request to a user;
(f) processing the client request by querying the at least one database for patient/provider information pertaining to the user, to a patient of the user, to a provider of the user, or to a potential provider of the user, using a visual selection referral application installed on one or more of the electronic computing machines; and
(g) sending a response to the electronic client computing machine over the inter-connected electronic data network, wherein the response provides the patient/provider information usable for the medical visual referral tool, and wherein at least some of the patient/provider information is to be visually represented at the client machine and displayed on an electronic geographical map.

2. The method of claim 1, wherein the obtaining step further comprises locating the one or more data sources.

3. The method of claim 2, wherein one or more uniform resource locators (URLs) are used to locate the one or more data sources.

4. The method of claim 1, wherein the obtaining step further comprises, subsequently after locating the one or more data sources, downloading the data from the one or more data sources.

5. The method of claim 4, wherein a download request is sent to the one or more located data sources and, in response to the download request, downloading the data from the one or more data sources.

6. The method of claim 1, wherein the preparing step further comprises analyzing the obtained electronically encoded data to determine one or more performance metrics of one or more providers.

7. The method of claim 1, wherein the patient/provider information comprises a quality score associated with a provider and a geographic location, wherein the quality score is reflected on the electronic geographic map at the geographic location.

8. The method of claim 1, wherein at least one of the data sources comprise non-volatile computer-readable memory medium which may be locally connected to the one or more servers.

9. The method of claim 1, wherein at least one of the data sources is co-located at the same geographic location as at least one of the servers.

10. A medical visual referral system, comprising:
at least one database stored on a computer-readable memory; and
one or more servers, wherein the one or more servers each comprise:
a plurality of electronic computing machines, wherein the electronic computing machines each comprise:
a processor; and
a computer-readable memory accessible by the processor;
wherein the electronic computing machines are configured to:
(a) obtain electronically encoded data from one or more data sources, wherein the electronically encoded data comprises information pertaining to a patient and/or a medical provider;
(b) prepare the data for standardized entry into one or more of the databases using the processor of at least one of the electronic computing machines;
(c) store the standardized data into the one or more databases;
(d) receive a client request for access to the medical visual referral tool from an electronic client computing machine via an inter-connected electronic data network;
(e) resolve the client request to a user;
(f) process the client request by querying the at least one database for patient/provider information pertaining to the user, to a patient of the user, to a provider of the user, or to a potential provider of the user, using a visual selection referral application installed on one or more of the electronic computing machines; and
(g) send a response to the electronic client computing machine over the inter-connected electronic data network, wherein the response provides the patient/provider information usable for the medical visual referral tool, and wherein at least some of the patient/provider information is to be visually represented at the client machine and displayed on an electronic geographical map.

11. The medical visual referral system of claim 10, wherein the at least one database is stored on the computer-readable memory of one or more of the electronic computing machines.

12. The medical visual referral system of claim 10, wherein at least some of the servers are co-located at the same geographic location.

13. The medical visual referral system of claim 10, wherein at least one of the servers are co-located at the same geographic location as the at least one database.

14. A method of providing patient/provider information to be used for a medical visual referral tool, the method being carried out by a medical visual referral system, the medical visual referral system comprising:
at least one database stored on a computer-readable memory; and
one or more servers, wherein each of the servers comprises a plurality of electronic computing machines, wherein the electronic computing machines each comprise a processor and a computer-readable memory that is accessible by the processor;
wherein the method comprises:
(a) obtaining electronically encoded data from one or more data sources via an inter-connected data network, wherein the electronically encoded data comprises information pertaining to a patient and/or a medical provider;
(b) standardizing the obtained electronically encoded data using the processor of at least one of the electronic computing machines;
(c) storing the standardized data into one or more of the databases;
(d) receiving a client request from the medical visual referral tool via an inter-connected electronic data network, wherein the medical visual referral tool is being carried out on an electronic client computing machine;
(e) resolving the client request to a user of the medical visual referral tool;
(f) retrieving patient/provider information pertaining to the user, to a patient of the user, to a provider of the user, or to a potential provider of the user, from any one or more of the databases using a visual selection referral application installed on one or more of the electronic computing machines; and
(g) sending a response to the electronic client computing machine over the inter-connected electronic data network, wherein the response provides the patient/provider information usable for the medical visual referral tool, and wherein at least some of the patient/provider information is displayed on an electronic geographical map at the electronic client computing machine.
